(19) United States
(12) Patent Application Publication
(10) Pub. No.: US 2026/0066839 A1
(43) Pub. Date: Mar. 5, 2026

(54) SOLAR TRACKER SUPPORT FRAME HARD STOPS AND BRACES

(71) Applicant: Nextracker LLC, Fremont, CA (US)

(72) Inventors: Harry Van, Oakland, CA (US); Ryan Patel, Pleasanton, CA (US); Zachary Forrest Steele, Belmont, CA (US)

(21) Appl. No.: 19/301,695

(22) Filed: Aug. 15, 2025

Related U.S. Application Data
(60) Provisional application No. 63/689,058, filed on Aug. 30, 2024.

(51) Int. Cl. H02S 20/32

(52) U.S. Cl. CPC H02S 20/32

(57) ABSTRACT

A solar tracker support frame assembly includes a multi-leg solar tracker support frame, a hanging bearing housing assembly, a hard stop member, and a brace member. The hanging bearing housing assembly is at the multi-leg solar tracker support frame and is configured to support a torque tube below a bridge of the frame. The hard stop member interfaces with at least one of a first leg, a second leg, and the bridge of the frame. The hard stop member includes an interference surface configured to contact the torque tube and thereby impede further movement of the torque tube beyond the interference surface. The brace member extends between the first and second legs of the frame below the bridge and below the hard stop member.

### RELATED APPLICATIONS

This application claims the benefit of U.S. Provisional Application No. 63/689,058, filed Aug. 30, 2024, the entire contents of which are incorporated herein by reference.

### TECHNICAL FIELD

This disclosure relates generally to devices, systems, assemblies, and methods relating to hard stops and braces for solar tracker support frame assemblies. Such embodiments disclosed herein include solar tracker support frame assemblies having a hard stop member and/or a brace member.

### BACKGROUND

Solar panels can convert sunlight into energy. As an example, solar photovoltaic panels convert sunlight directly into electricity for a variety of applications. Solar panels are generally composed of an array of solar cells, which are interconnected to each other. The cells are often arranged in series and/or parallel groups of cells in series.

Solar tracker systems can be used to dynamically orient a plurality of solar modules, for instance, by moving the solar modules throughout the course of a given day to track the movement of the sun and thereby increase the efficiency and productivity of the solar modules. Typical solar tracker systems installed in the field support the solar modules at the ground surface using a foundation at the ground surface. When so installed in the field, solar tracker system supports can be subjected to various loading both from operation of the solar tracker and from ambient conditions, such as wind.

### SUMMARY

This disclosure in general describes embodiments of devices, systems, assemblies, and methods relating to hard stops and braces for solar tracker support frame assemblies, for instance, to help increase the structural integrity and stability of a solar tracker support frame, such as to better withstand loading applied in the field. Such embodiments disclosed herein include solar tracker support frame assemblies having a hard stop member and/or a brace member. For example, embodiments disclosed herein include a multi-leg solar tracker support frame, with a hanging bearing housing assembly and one or both of a hard stop member and a brace member at the multi-leg solar tracker support frame. Certain such embodiments disclosed herein relate to a multi-leg solar tracker support frame (e.g., a solar tracker A-frame) that includes both at least one hard stop member and at least one brace member. For various such embodiments disclosed herein, a hanging bearing assembly can be configured to be mounted at a multi-leg solar tracker support frame to position a torque tube at the hanging bearing assembly below an apex at the multi-leg solar tracker support frame (e.g., below a bridge of the multi-leg solar tracker support frame), and the hard stop member can include an interference surface that is configured to contact such torque tube and thereby impede further movement of the torque tube beyond that interference surface. For various additional or alternative embodiment, the hanging bearing assembly can be configured to be mounted at a multi-leg solar tracker support frame to position a torque tube at the hanging bearing assembly below an apex at the multi-leg solar tracker support frame (e.g., below a bridge of the multi-leg solar tracker support frame), and the brace member can extend between legs of the multi-leg solar tracker support frame below the bridge and below the hard stop member. These embodiments can be useful in helping to increase the structural stability of a multi-leg solar tracker support frame installed in the field, for instance, when dynamic loads (e.g., wind) are applied at the multi-leg solar tracker support frame during operation in the field.

Such embodiments disclosed herein can be useful in increasing the structural stability associated with the solar tracker support frame but yet can do so in a manner that is cost effective and reduces the number of extra components and fastening member interconnections needed when installing the solar tracker support frame in the field. Moreover, certain exemplary embodiments disclosed herein can include a hanging bearing housing assembly configured to be mounted at a multi-leg solar tracker support frame to position a torque tube at the hanging bearing assembly below an apex at the multi-leg solar tracker support frame, which can lower the elevation of the torque tube and rotational axis of the solar tracker system and thereby may help to reduce the magnitude of dynamic loads (e.g., wind loads) transferred to the foundation which can help to reduce the cost and complexity associated with foundations that would otherwise need to support the greater magnitude dynamic loads resulting from a higher-elevation positioning of the torque tube. Instead, one or more embodiments of a hard stop and/or a brace can be used at solar tracker support frame to help increase the structural stability of the solar tracker support frame without unduly increasing the costs, including installation costs, associated with the increased structural stability.

One embodiment includes a solar tracker support frame assembly. This assembly embodiment includes a multi-leg solar tracker support frame, a hanging bearing housing assembly, a hard stop member, and a brace member. The multi-leg solar tracker support frame includes a first frame leg, a second frame leg, and a bridge extending between the first frame leg and the second frame leg. The hanging bearing housing assembly is at the multi-leg solar tracker support frame and is configured to support a torque tube. The hanging bearing housing assembly includes a bearing sleeve and a torque tube connector. The torque tube connector is configured to couple the torque tube to the bearing sleeve below the bridge. The hard stop member interfaces with at least one of the first frame leg, the second frame leg, and the bridge. The hard stop member includes an interference surface configured to contact the torque tube and thereby impede further movement of the torque tube beyond the interference surface. The brace member extends between the first frame leg and the second frame leg below the bridge and below the hard stop member.

In a further embodiment of this assembly, the hard stop member interfaces with the bridge and at least one of the first frame leg and the second frame leg such that the hard stop member extends along the bridge and the at least one of the first frame leg and the second frame leg.

In a further embodiment of this assembly, the hard stop member is a first hard stop member and the interference surface is a first interference surface. The first hard stop member interfaces with the first frame leg and the bridge, and the first interference surface is configured to contact the torque tube and thereby impede further movement of the torque tube beyond the interference surface in a first direction. The assembly further includes a second hard stop member. The second hard stop member interfaces with the second frame leg and the bridge. The second hard stop member includes a second interference surface configured to contact the torque tube and thereby impede further movement of the torque tube beyond the interference surface in a second direction that is opposite the first direction. For some such examples, the first hard stop member interfaces with the first frame leg and the bridge at a first side of the multi-leg solar tracker support frame, and the second hard stop member interfaces with the second frame leg and the bridge at a second side of the multi-leg solar tracker support frame opposite the first side. For instance, the brace member can be a first brace member extending between the first frame leg and the second frame leg below the bridge and below the first hard stop member at the first side of the multi-leg solar tracker support frame, and the assembly can further include a second brace member extending between the first frame leg and the second frame leg below the bridge and below the second hard stop member at the second side of the multi-leg solar tracker support frame. In some such examples, the first brace member includes a first brace member first arm that extends parallel to the bridge between the first frame leg and the second frame leg at the first side of the multi-leg solar tracker support frame and a first brace member second arm that extends at a skewed angle between the first frame leg and the second frame leg at the first side of the multi-leg solar tracker support frame. Similarly, in some such examples, the second brace member includes a second brace member first arm that extends parallel to the bridge between the first frame leg and the second frame leg at the second side of the multi-leg solar tracker support frame and a second brace member second arm that extends at a skewed angle between the first frame leg and the second frame leg at the second side of the multi-leg solar tracker support frame. In one particular such example, the first brace member can be integral with the first hard stop member, and the second brace member can be integral with the second hard stop member.

In a further embodiment of this assembly, the interference surface included at the hard stop member includes a first planar interference end surface at one end of the interference surface, a second planar interference end surface at another, opposite end of the interference surface, and an intermediate planar interference surface between the first planar interference end surface and the second planar interference end surface. For example, the hard stop member can have a vertical end wall that includes one or more coupling apertures for coupling the hard stop member to the multi-leg solar tracker support frame, and the hard stop member can further include a flange that extends out from the vertical end wall, with the interference surface formed at the flange. As another example, the hard stop member can include a first vertical end wall that includes one or more first coupling apertures, a second vertical end wall that includes one or more second coupling apertures, with the second vertical wall spaced apart from the first vertical wall, and a horizontal end wall that extends between the first vertical wall and the second vertical wall, the interference surface formed at the horizontal end wall.

In a further embodiment of this assembly, the interference surface included at the hard stop member includes a first lower interference surface at a first side of the interference surface, a second lower interference surface at a second, opposite side of the interference surface, and an intermediate raised interference surface between the first lower interference surface and the second lower interference surface. For example, the hard stop member can include: a first vertical end wall that includes one or more first coupling apertures, a second vertical end wall that includes one or more second coupling apertures, with the second vertical wall spaced apart from the first vertical wall, and a horizontal end wall that extends between the first vertical wall and the second vertical wall, the interference surface formed at the horizontal end wall.

In a further embodiment of this assembly, the hard stop member is coupled to the bridge and at least one of the first frame leg and the second frame leg such that the interference surface curves from the bridge to the at least one of the first frame leg and the second frame leg. In one such example, the bearing sleeve can include a first bearing sleeve portion and a hanging bearing sleeve portion. The first bearing sleeve portion can interface with the bridge, and the hanging bearing sleeve portion can extend out from the first bearing sleeve portion below the bridge such that the hanging bearing sleeve portion is at a common elevation with the interference surface. The torque tube connector can be, for example, a pin.

Another embodiment disclosed herein includes a solar tracker brace and hard stop system. This system embodiment includes a first brace and hard stop member and a second brace and hard stop member. The first brace and hard stop member includes a first base, a first brace member extending out from the first base at an angle between zero and ninety degrees, and a first hard stop member extending out from the first base. The first hard stop member includes a first interference surface configured to contact a torque tube and thereby impede further movement of the torque tube in a first direction beyond the first interference surface. The first interference surface extends out from the first base in a direction perpendicular to a direction at which the first brace member extends out from the first base. The second brace and hard stop member includes a second base, a second brace member extending out from the second base at an angle between zero and ninety degrees, and a second hard stop member extending out from the second base. The second hard stop member includes a second interference surface configured to contact the torque tube and thereby impede further movement of the torque tube in a second direction, opposite the first direction, beyond the second interference surface. The second interference surface extends out from the second base in a direction perpendicular to a direction at which the second brace member extends out from the second base.

In a further embodiment of this system, each of the first base, the first brace member, and the first hard stop member include at least one coupling aperture, and each of the second base, the second brace member, and the second hard stop member include at least one coupling aperture.

In a further embodiment of this system, the first brace member of the first brace and hard stop member further includes a first member first brace arm extending out from, and perpendicular to, the first base. And the second brace member of the second brace and hard stop member further includes a second member first brace arm extending out from, and perpendicular to, the second base. In one such example, the first brace member of the first brace and hard stop member further includes a first member second brace arm extending out from the first brace member first arm at a side of the first brace member first arm opposite the first base, and the first brace member second arm includes at least one coupling aperture. Similarly, the second brace member of the second brace and hard stop member further includes a second member second brace arm extending out from the second brace member first arm at a side of the second brace member first arm opposite the second base, and the second brace member second arm includes at least one coupling aperture. In one more particular such example, the first brace member of the first brace and hard stop member further includes a first member third brace arm extending out from the first base in a direction opposite the first member first brace arm. And, similarly for such example, the second brace member of the second brace and hard stop member further includes a second member third brace arm extending out from the second base in a direction opposite the second member first brace arm.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular examples of the present invention and therefore do not limit the scope of the invention. The drawings are intended for use in conjunction with the explanations in the following detailed description wherein like reference characters denote like elements. Examples of the present invention will hereinafter be described in conjunction with the appended drawings.

FIG. 1 is a schematic, elevational view diagram of a solar tracker system that includes a plurality of solar tracker support frame assemblies.

FIGS. 2A and 2B illustrate one exemplary embodiment of a solar tracker support frame assembly coupled to a torque tube of a solar tracker system. FIG. 2A is a schematic, elevational view diagram of the solar tracker support frame assembly embodiment, and FIG. 2B is a perspective view of the solar tracker support frame assembly embodiment.

FIGS. 3A-3D illustrate one exemplary embodiment of a solar tracker support frame assembly. FIG. 3A is a perspective view of an embodiment of a first brace and hard stop member, FIG. 3B is a perspective view of an embodiment of a second brace and hard stop member, FIG. 3C is an exploded view showing assembly of the first and second brace and hard stop members at a multi-leg solar tracker support frame, and FIG. 3D is perspective view of the solar tracker support frame assembly with the first and second brace and hard stop members assembled at a multi-leg solar tracker support frame.

FIGS. 4A-4C illustrate another exemplary embodiment of a solar tracker support frame assembly. FIG. 4A is a perspective view of an embodiment of a first brace and hard stop member, FIG. 4B is a perspective view of an embodiment of a second brace and hard stop member, and FIG. 4C is a perspective view of the solar tracker support frame assembly with the first and second brace and hard stop members assembled at a multi-leg solar tracker support frame.

FIGS. 5A and 5B illustrate another exemplary embodiment of a solar tracker support frame assembly with first and second brace and hard stop members assembled at a multi-leg solar tracker support frame, where the brace and hard stop are separate components of each of the first and second brace and hard stop members. FIG. 5A is a perspective view of a first side of the solar tracker support frame assembly, and FIG. 5B is a perspective view of a second, opposite side of the solar tracker support frame assembly.

FIGS. 6A and 6B illustrate one exemplary embodiment of an interference surface at a hard stop member. FIG. 6A is an elevational view of a solar tracker support frame assembly having a hard stop member with the embodiment of the interference surface, and FIG. 6B is an elevational view of the hard stop member with the embodiment of the interference surface in isolation.

FIGS. 7A and 7B illustrate another exemplary embodiment of an interference surface at a hard stop member. FIG. 7A is a perspective view of a solar tracker support frame assembly having a hard stop member with the embodiment of the interference surface, and FIG. 7B is a perspective view of the hard stop member with the embodiment of the interference surface in isolation.

FIGS. 8A-8C illustrate another exemplary embodiment of an interference surface that can be included at any of a variety of hard stop embodiments. FIG. 8A is a perspective view of a solar tracker support frame assembly having a hard stop with the embodiment of the interference surface, FIG. 8B is a perspective view of one exemplary embodiment of a hard stop with the embodiment of the interference surface, and FIG. 8C is an elevational view of the hard stop of FIG. 8B with the embodiment of the interference surface.

FIGS. 9A-9C illustrate an exemplary embodiment of a brace member. FIG. 9A is a perspective view of the embodiment of the brace member, FIG. 9B is an exploded view showing assembly of first and second brace members, of FIG. 9A, at a multi-leg solar tracker support frame, and FIG. 9C is an elevational view of a solar tracker support frame assembly with the first and second brace members assembled at the multi-leg solar tracker support frame.

FIGS. 10A and 10B illustrate another exemplary embodiment of a brace member. FIG. 10A is a plan view of the brace member, and FIG. 10B is an elevational view of a solar tracker support frame assembly with the brace member assembled at a multi-leg solar tracker support frame.

### DETAILED DESCRIPTION

The following detailed description is exemplary in nature and is not intended to limit the scope, applicability, or configuration of the invention in any way. Rather, the following description provides some practical illustrations for implementing examples of the present invention. Those skilled in the art will recognize that many of the noted examples have a variety of suitable alternatives.

Embodiments disclosed herein include various devices, systems, assemblies, and methods relating to hard stops and braces for solar tracker support frame assemblies. Such embodiments disclosed herein include solar tracker support frame assemblies having a hard stop member and/or a brace member. For example, embodiments disclosed herein include a multi-leg solar tracker support frame, with a hanging bearing housing assembly and one or both of a hard stop member and a brace member at the multi-leg solar tracker support frame. Certain such embodiments disclosed herein relate to a multi-leg solar tracker support frame (e.g., a solar tracker A-frame) that includes both at least one hard stop member and at least one brace member. For various such embodiments disclosed herein, a hanging bearing assembly can be configured to be mounted at a multi-leg solar tracker support frame to position a torque tube at the hanging bearing assembly below an apex at the multi-leg solar tracker support frame (e.g., below a bridge of the multi-leg solar tracker support frame), and the hard stop member can include an interference surface that is configured to contact such torque tube and thereby impede further movement of the torque tube beyond that interference surface. For various additional or alternative embodiment, the hanging bearing assembly can be configured to be mounted at a multi-leg solar tracker support frame to position a torque tube at the hanging bearing assembly below an apex at the multi-leg solar tracker support frame (e.g., below a bridge of the multi-leg solar tracker support frame), and the brace member can extend between legs of the multi-leg solar tracker support frame below the bridge and below the hard stop member. These embodiments can be useful in helping to increase the structural stability of a multi-leg solar tracker support frame installed in the field, for instance, when dynamic loads (e.g., wind) are applied at the multi-leg solar tracker support frame during operation in the field.

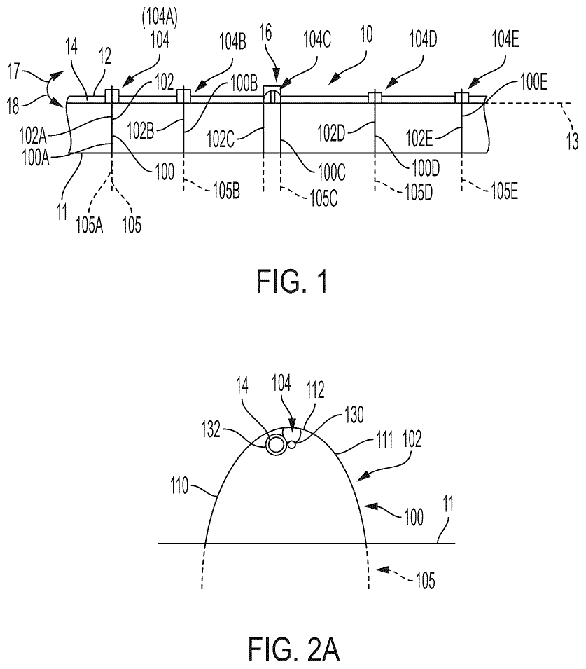

FIG. 1 is a schematic, elevational view diagram of a solar tracker system 10. The solar tracker system 10 includes a torque tube 14 and a plurality of solar modules 12 that are coupled to the torque tube 14 to thereby rotate with the torque tube 14. The system 10 can further include a motive source 16 that is coupled to the torque tube 14 to impart a rotational motive force (e.g., torque) to the torque tube 14 to cause the torque tube 14 to rotation in a direction 17 and in an opposite direction 18. The system 10 can be configured to rotate the torque tube 14 in directions 17, 18 over time to change the orientation of the solar modules 12 relative to the sun.

Each of the one of more solar modules 12 can include a frame and a plurality of photovoltaic cells that are configured to receive sunlight and as a result generate electrical energy. A module mounting assembly can connect at least one solar module 12 to the torque tube 14, and the torque tube can be configured to rotatably move one or more such solar modules 12. For instance, the torque tube 14 can be actuated by a controller (e.g., that is in communication with the motive source 16) to cause the torque tube 14 to move, such as rotate about a longitudinal axis 13 of the torque tube 14. Rotation of the torque tube 14 in the directions 17 and/or 18 can facilitate more optimized solar power generation at the photovoltaic cells at the solar modules 12 by adjusting the angle of the one or more solar modules at one or more times (e.g., at times during a given day) to help “track” the sun as it moves over that period of time and, thereby, maintain more optimized positioning of the photovoltaic cells relative to the angle of sunlight irradiation at that given time of the day.

To support the torque tube 14, the system 10 can include a plurality of solar tracker support frame assemblies 100. The embodiment illustrated at FIG. 1 shows a plurality of solar tracker support frame assemblies 100A, 100B, 100C, 100D, 100E each rotatably supporting torque tube 14 so that torque ube 14 can rotate, in directions 17, 18, relative to the support frame assemblies 100A-100E. Each solar tracker support frame assembly 100 can include a multi-leg solar tracker support frame 102 and a hanging bearing housing assembly 104. Thus, as shown at the example of FIG. 1, the solar tracker support frame assembly 100A includes the multi-leg solar tracker support frame 102A and the hanging bearing housing assembly 104A, the solar tracker support frame assembly 100B includes the multi-leg solar tracker support frame 102B and the hanging bearing housing assembly 104B, the solar tracker support frame assembly 100C includes the multi-leg solar tracker support frame 102C and the hanging bearing housing assembly 104C, the solar tracker support frame assembly 100D includes the multi-leg solar tracker support frame 102D and the hanging bearing housing assembly 104D, and the solar tracker support frame assembly 100E includes the multi-leg solar tracker support frame 102E and the hanging bearing housing assembly 104E. The respective hanging bearing housing assembly 104A-104E at each solar tracker support frame assembly 100A-100E can receive and rotatably support the torque tube 14 thereat. Thus, the torque tube 14 can rotate in the directions 17, 18 while rotatably supported at each of the hanging bearing housing assemblies 104A-104E. The respective multi-leg solar tracker support frame 102A-102E at each solar tracker support frame assembly 100A-100E can couple to the respective hanging bearing housing assembly 104A-104E.

Each of the respective multi-leg solar tracker support frames 102A-102E can be supported at a ground surface 11 via a foundation component 105. As shown at FIG. 1, the multi-leg solar tracker support frame 102A is supported at ground surface 11 via foundation component 105A, the multi-leg solar tracker support frame 102B is supported at ground surface 11 via foundation component 105B, the multi-leg solar tracker support frame 102C is supported at ground surface 11 via foundation component 105C, the multi-leg solar tracker support frame 102D is supported at ground surface 11 via foundation component 105D, and the multi-leg solar tracker support frame 102E is supported at ground surface 11 via foundation component 105E. The foundation components 105A-105E can extend into and below ground surface 11 so as to be embedded into the ground surface 11 to support the above-ground, respective multi-leg solar tracker support frame 102A-102E and associated respective hanging bearing housing assembly 104A-104E. The foundation components 105A-105E can, for example, one or more blade piles (e.g., a pair of blade piles), one or more screw piles (e.g., a pair of screw piles), and/or one or more concrete footings (e.g., a pair of concrete footings) as examples.

FIG. 1 shows the system 10 at a side elevational view looking in an east-west orientation at the multi-leg solar tracker support frames 102A-102E and associated hanging bearing housing assemblies 104A-104E. As illustrated, the multi-leg solar tracker support frames 102A, 102B, 102D, 102E and associated hanging bearing housing assemblies 104A, 104B, 104D, 104E can be oriented in one direction, while the multi-leg solar tracker support frame 102C associated hanging bearing housing assembly 104C can be oriented in a different direction, such as generally ninety degrees offset from the multi-leg solar tracker support frames 102A, 102B, 102D, 102E. For instance, the multi-leg solar tracker support frames 102A, 102B, 102D, 102E and associated hanging bearing housing assemblies 104A, 104B, 104D, 104E can face one of east-west and north-south while the multi-leg solar tracker support frame 102C and associated hanging bearing housing assembly 104C can face the other of east-west and north-south.

Installing a typical solar tracker system in the field can oftentimes necessitate a significant number of interconnections between a significant number of components ranging from subterranean foundation components and connections to above-ground bearing connections and solar module support connections. The solar tracker support frame assembly 100 embodiments disclosed herein can be useful in reducing the cost, time, and labor associated with installing a solar tracker system in the field. For example, such embodiments disclosed herein can be adapted for use with a wide variety of foundation types, can help to reduce the cost of solar tracker installation in the field by reducing a number of components and inter-component connections and fastening members necessary to effectively couple a torque tube of a solar tracker system to a hanging bearing housing assembly that is supported by a multi-leg solar tracker support frame at a foundation, and/or can include the hanging bearing housing assembly configured to be mounted at a multi-leg solar tracker support frame to position a torque tube at the hanging bearing assembly below an apex at the multi-leg solar tracker support frame to thereby help to reduce the magnitude of dynamic loads (e.g., wind loads) transferred to the foundation component.

For example, to help reduce cost, time, and labor associated with installing a solar tracker system in the field, embodiments disclosed herein can include solar tracker support frame assemblies having a multi-leg solar tracker support frame and a hanging bearing housing assembly at the multi-leg solar tracker support frame. The multi-leg solar tracker support frame (e.g., a solar tracker A-frame) can be adjusted relative to a ground surface and/or the hanging bearing assembly is configured to be mounted at a multi-leg solar tracker support frame to position a torque tube at the hanging bearing assembly below an apex at the multi-leg solar tracker support frame (e.g., below a bridge of the multi-leg solar tracker support frame).

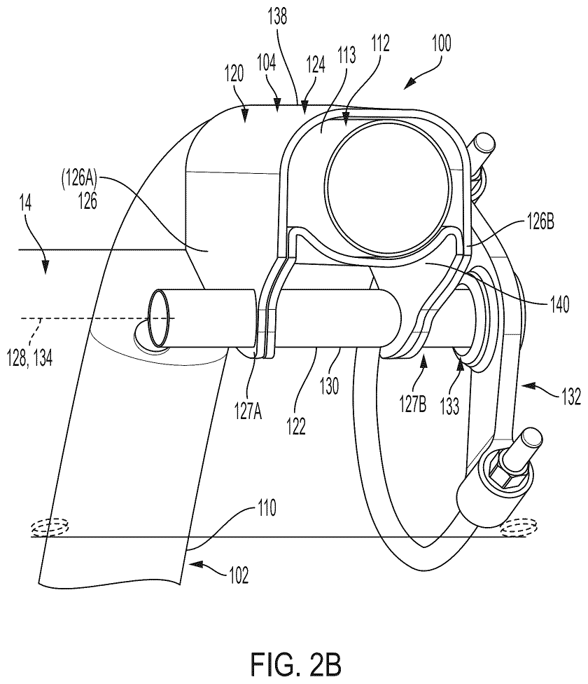

FIGS. 2A-2B illustrate one exemplary embodiment of solar tracker support frame assembly 100 coupled to torque tube 14. FIG. 2A is a schematic, elevational view diagram of the solar tracker support frame assembly 100, and FIG. 2B is a perspective view of the solar tracker support frame assembly 100.

The solar tracker support frame assembly 100 includes the multi-leg solar tracker support frame 102 and the hanging bearing housing assembly 104. The solar tracker support frame assembly 100 can be supported at ground surface 11 via one or more foundation components 105. As shown here, the solar tracker support frame assembly 100 can be supported at ground surface 11 via a pair of foundation components 105. The one or more foundation components 105 can extend into and below ground surface 11 to anchor the solar tracker support frame assembly 100 to the ground surface 11. The one or more foundation components 105 can be any of a variety of types of suitable subterranean anchor components that can be embedded in the ground and coupled to the solar tracker support frame assembly 100.

The multi-leg solar tracker support frame 102 can include a first frame leg 110, a second frame leg 111, and a bridge 112 extending between the first frame leg 110 and the second frame leg 111. The first frame leg 110 and the second frame leg 111 can be supported at the ground surface 11 via foundation component 105 that is at least partially embedded within the ground surface 11. As shown for the illustrated example, the first frame leg 110 can be supported at a first foundation component 105 that is at least partially embedded within the ground surface 11 while the second frame leg 111 can be supported at a second, different foundation component 105 that is at least partially embedded within the ground surface 11. The bridge 112 can bridge between and interconnect the first and second frame legs 110, 111. In some examples, the multi-leg solar tracker support frame 102 can have the first frame leg 110, the second frame leg 111, and the bridge 112 as integral components defining a single piece body at the multi-leg solar tracker support frame 102, though in other examples the multi-leg solar tracker support frame 102 can have the first frame leg 110, the second frame leg 111, and the bridge 112 as individual components that are fastened together, such as via the bridge 112. The one or more foundation components 105 can be inserted (e.g., rammed, rotationally driven, etc.) into ground surface 11 and then the multi-leg solar tracker support frame 102 can be coupled to the ground embedded one or more foundation components 105.

The hanging bearing housing assembly 104 can be at the multi-leg solar tracker support frame 102. The hanging bearing housing assembly 104 can be configured to support the torque tube 14 such that the torque tube 14 is supported via the ground surface 11 by the foundation component(s) 105, the multi-leg solar tracker support frame 102, and the hanging bearing housing assembly 104. For example, the hanging bearing housing assembly 104 can be configured to rotatably support the torque tube 14 thereat such that the torque tube 14 can rotate relative to the hanging bearing housing assembly 104 to change an orientation of solar modules relative to the sun. The hanging bearing housing assembly 104 can include a bearing sleeve 120 and a torque tube connector 122. The bearing sleeve 120 can be configured to suspend the torque tube connector 122 from the multi-leg solar tracker support frame 102, and the suspended torque tube connector 122 can be configured to couple to the torque tube 14 so as to rotatably support the torque tube 14 at the hanging bearing housing assembly 104. As shown for the illustrated example, the torque tube 14 can be suspended from the hanging bearing housing assembly 104 below the bridge 112 such that the torque tube 14 passes between the legs 110, 111 as the torque tube 14 passes under the bridge 112.

The bearing sleeve 120 at the hanging bearing housing assembly 104 can include a first bearing sleeve portion 124 and a hanging bearing sleeve portion 126. The first bearing sleeve portion 124 can be configured to interface with the bridge 112, and the hanging bearing sleeve portion 126 can be configured to extend out from the first bearing sleeve portion 124 below the bridge 112. The illustrated embodiment shows that the first bearing sleeve portion 124 can wrap around at least a portion of the bridge 112. For instance, as shown best at the example of FIG. 2B, the first bearing sleeve portion 124 can be configured to wrap around at least half of a perimeter surface 113 of the bridge 112. The first bearing sleeve portion 124 can define an apex 138 at the multi-leg solar tracker support frame 102 such that the apex 138 at the first bearing sleeve portion 124 is at a height relative to the ground surface 11 above a highest elevation portion of the multi-leg solar tracker support frame 102. The hanging bearing sleeve portion 126 can be configured to couple to the torque tube connector 122 so as to couple the torque tube 14 to the bearing sleeve 120 at the hanging bearing sleeve portion 126. For instance, as shown for the example here, the torque tube connector 122 can be configured to couple the torque tube 14 to the hanging bearing housing assembly 104 at least at the hanging bearing sleeve portion 126 below the bridge 112 of the multi-leg solar tracker support frame 102.

For example, the hanging bearing sleeve portion 126 can include a first hanging bearing sleeve portion 126A at a first side of the bridge 112 and a second hanging bearing sleeve portion 126B at a second, opposite side of the bridge 112. The first hanging bearing sleeve portion 126A can include a first torque tube connector aperture 127A at the first side of the bridge 112, and the second hanging bearing sleeve portion 126B comprises a second torque tube connector aperture 127B at the second, opposite side of the bridge 112. For instance, in one specific such example shown here, the first torque tube connector aperture 127A at the first side of the bridge 112 and the second torque tube connector aperture 127B at the second, opposite side of the bridge 112 can aligned on a connector aperture axis 128. The first and second torque tube connector apertures 127A, 127B can be configured to receive the torque tube connector 122 such that the torque tube connector 122 extends through the first and second torque tube connector apertures 127A, 127B at the hanging bearing sleeve portion 126 below the bridge 112 of the multi-leg solar tracker support frame 102.

The torque tube connector 122 of the illustrated embodiment of the hanging bearing housing assembly 104 includes a pin 130. As also shown for the illustrated embodiment at FIGS. 2A-2B, the solar tracker support frame assembly 100 can also include a U-bolt 132. The U-bolt 132 can be configured to receive and couple the pin 130 to the torque tube 14. For example, the pin 130 can extend through the first torque tube connector aperture 127A, at the first side of the bridge 112, extend through the second torque tube connector aperture 127B, at the second side of the bridge 112, and pass under the bridge 112 opposite the first bearing sleeve portion 124. The U-bolt 132 can receive and couple to the pin 130 via a pin aperture 133 at the U-bolt 132. As shown at the examples at FIG. 2B, the pin 130 can extend along a pin longitudinal axis 134 that is offset from central longitudinal axis 13 of the torque tube (e.g., with torque tube central longitudinal axis 13 being the rotational axis of the torque tube 14).

As illustrated at the example at FIGS. 2A-2B, the hanging bearing housing assembly 104 can further include a sub-bridge retainer 140. The sub-bridge retainer 140 can be configured to sit below the bridge 112 at the multi-leg solar tracker support frame 102 and between the hanging bearing sleeve portion 126. The pin 130 can be configured to extend through the first hanging bearing sleeve portion 126A at one side of the bridge 112, then through a first side of the sub-bridge retainer 140 at the one side of the bridge 112, then through a second, opposite side of the sub-bridge retainer 140 at another opposite side of the bridge 112, and then through the second hanging bearing sleeve portion 126B at the another opposite side of the bridge 112. The sub-bridge retainer 140 can be configured to increase the structural support at the hanging bearing housing assembly 104 on the pin 130 and/or to help prevent misalignment between or pulling-off of the pin 130 and the hanging bearing sleeve portion 126.

The following will disclose features relating to hard stops and braces for solar tracker support frame assemblies, for instance, such as the solar tracker support frame assemblies described previously. The inclusion of such hard stop(s) and/or brace(s) can help increase the structural integrity and stability of a solar tracker support frame, such as to better withstand loading applied in the field. Such embodiments disclosed herein can include a multi-leg solar tracker support frame, with a hanging bearing housing assembly and one or both of a hard stop member and a brace member at the multi-leg solar tracker support frame. Certain such embodiments disclosed herein relate to a multi-leg solar tracker support frame (e.g., a solar tracker A-frame) that includes both at least one hard stop member and at least one brace member.

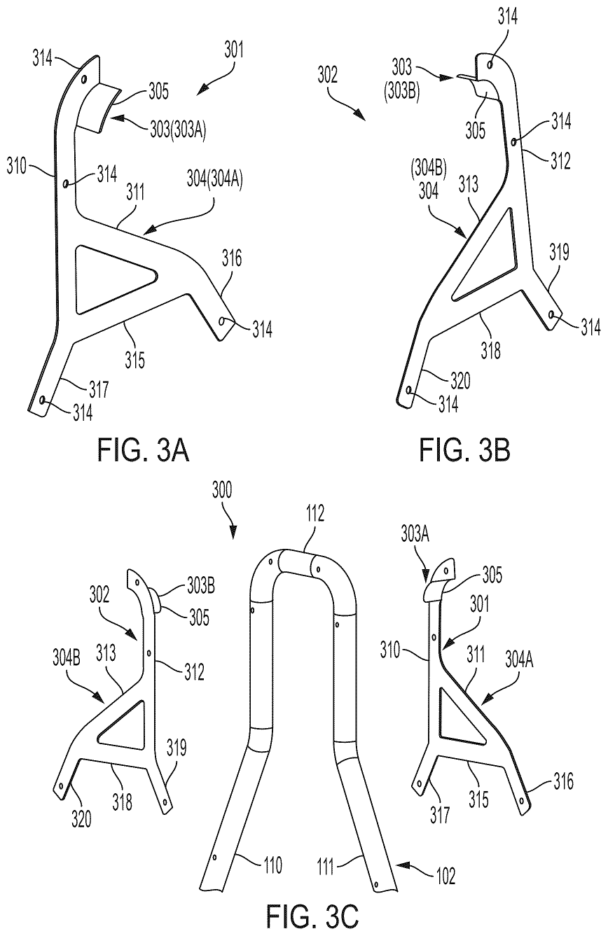

FIGS. 3A-3D illustrate one exemplary embodiment of a solar tracker support frame assembly 300. FIG. 3A is a perspective view of an embodiment of a first brace and hard stop member 301, FIG. 3B is a perspective view of an embodiment of a second brace and hard stop member 302, FIG. 3C is an exploded view showing assembly of the first and second brace and hard stop members 301, 302 at multi-leg solar tracker support frame 102, and FIG. 3D is perspective view of the solar tracker support frame assembly 300 with the first and second brace and hard stop members 301, 302 assembled at the multi-leg solar tracker support frame 102. As will be described further below, each of the first and second brace and hard stop members 301, 302 can include both a hard stop member 303 and a brace member 304. For instance, as illustrated, each of the first and second brace and hard stop members 301, 302 can be an integral component that includes both hard stop member 303 and brace member 304.

The illustrated embodiment of the first brace and hard stop member 301 includes hard stop member 303A and brace member 304A. The hard stop member 303A can be configured to interface with at least one of the first frame leg 110, the second frame leg 111, and the bridge 112. The hard stop member 303A can include an interference surface 305 that can be configured to contact the torque tube 14 and thereby impede further movement of the torque tube 14 beyond the interference surface 305. The brace member 304A can extend between the first frame leg 110 and the second frame leg 111 below the bridge 112 and below the hard stop member 303A (e.g., below the interference surface 305 of the hard stop member 303A).

The illustrated embodiment of the first brace and hard stop member 301 includes a first base 310, a first brace member arm 311 extending out from the first base 310 at a skewed angle between zero and ninety degrees (e.g., first brace member arm 311 extends out from the first base 310 at a skewed angle between thirty and sixty degrees, such as between forty and fifty degrees), and the hard stop member 303A extending out from the first base 310. The first hard stop member 303A includes the interference surface 305 configured to contact torque tube 14 and thereby impede further movement of torque tube 14 in a first direction 17 beyond the interference surface 305 at the first hard stop member 303A. As illustrated, the interference surface 305 at the first hard stop member 303A can extend out from the first base 310 in a direction perpendicular to a direction at which the first brace member arm 311 extends out from the first base 310. For example, as shown for the first brace and hard stop member 301, each of the first base 310, the first brace member arm 311, and the first hard stop member 303A can include at least one coupling aperture 314. Each of the coupling apertures 314 can be configured to couple the first brace and hard stop member 301 to the solar tracker support frame 102.

Further detailing the exemplary embodiment of the first brace member arm 311 of the first brace and hard stop member 301, the first brace member arm 311 can include a first member first brace arm 315 and a first member second brace arm 316. The first member first brace arm 315 can extend out from, and perpendicular to, the first base 310. The first member second brace arm 316 can extend out from the first brace member first arm 315 at a side of the first brace member first arm 315 opposite the first base 310. The first brace member second arm 316 can include at least one coupling aperture 314, for instance, to help couple the first brace and hard stop member 301 to the solar tracker support frame 102 at the first brace member second arm 316. As also shown for the illustrated embodiment here of the first brace and hard stop member 301, the first brace member 304A can further include a first member third brace arm 317 that can extend out from the first base 310 in a direction opposite the first member first brace arm 316. The first member third brace arm 317 can also include at least one coupling aperture 314, for instance, to help couple the first brace and hard stop member 301 to the solar tracker support frame 102 at the third brace arm 317.

The illustrated embodiment of the second brace and hard stop member 302 includes hard stop member 303B and brace member 304B. The hard stop member 303B can be configured to interface with at least one of the first frame leg 110, the second frame leg 111, and the bridge 112. The hard stop member 304B can include interference surface 305 that can be configured to contact the torque tube 14 and thereby impede further movement of the torque tube 14 beyond the interference surface 305. The brace member 304B can extend between the first frame leg 110 and the second frame leg 111 below the bridge 112 and below the hard stop member 303B (e.g., below the interference surface 305 of the hard stop member 303B).

The illustrated embodiment of the second brace and hard stop member 302 includes a second base 312, a second brace member arm 313 extending out from the second base 312 at a skewed angle between zero and ninety degrees (e.g., second brace member arm 313 extends out from the second base 312 at a skewed angle between thirty and sixty degrees, such as between forty and fifty degrees), and the hard stop member 303B extending out from the second base 312. The second hard stop member 303B includes the interference surface 305 configured to contact torque tube 14 and thereby impede further movement of torque tube 14 in a second direction 18 (e.g., which can be opposite the first direction 17) beyond the interference surface 305 at the second hard stop member 303B. As illustrated, the interference surface 305 can extend out from the second base 312 in a direction perpendicular to a direction at which the second brace member arm 313 extends out from the second base 312. For example, as shown for the second brace and hard stop member 302, each of the second base 312, the second brace member arm 313, and the second hard stop member 303B can include at least one coupling aperture 314. And each of the coupling apertures 314 can be configured to couple the second brace and hard stop member 301 to the solar tracker support frame 102.

Further detailing the exemplary embodiment of the second brace member arm 313 of the second brace and hard stop member 302, the second brace member arm 313 can include a second member first brace arm 318 and a second member second brace arm 319. The second member first brace arm 318 can extend out from, and perpendicular to, the second base 312. The second member second brace arm 319 can extend out from the second brace member first arm 318 at a side of the second brace member first arm 318 opposite the second base 312. The second member second brace arm 319 can include at least one coupling aperture 314, for instance, to help couple the second brace and hard stop member 302 to the solar tracker support frame 102 at the second brace member second brace arm 319. As also shown for the illustrated embodiment here of the second brace and hard stop member 302, the second brace member arm 313 can further include a second member third brace arm 320 that can extend out from the second base 312 in a direction opposite the second member first brace arm 318. The second member third brace arm 320 can also include at least one coupling aperture 314, for instance, to help couple the second brace and hard stop member 302 to the solar tracker support frame 102 at the third brace arm 320.

FIGS. 3C and 3D illustrate the first and second brace and hard stop members 301, 302 applied to the solar tracker support frame 102. As illustrated for the embodiment shown here, the first hard stop member 303A can interface with frame leg 110 and bridge 112, and the interference surface 305 at the first hard stop member 303A can be configured to contact the torque tube 14 and thereby impede further movement of the torque tube 14 beyond the interference surface 305 at the first hard stop member 303A in first direction 17. As also illustrated for the embodiment shown here, the second hard stop member 303B can interface with frame leg 111 and bridge 112, and the interference surface 305 at the second hard stop member 303B can be configured to contact the torque tube 14 and thereby impede further movement of the torque tube 14 beyond the interference surface 305 at the second hard stop member 303B in second direction 18. For instance, the interference surface 305 at the first hard stop member 303A can project out from the bridge 112 and/or one of the legs 110, 111 at a first side (e.g., a north or south side) of the solar tracker support frame 102, and the interference surface 305 at the second hard stop member 303B can project out from the bridge 112 and/or the other of the legs 110, 111 at a second opposite side (e.g., the other of north and south side) of the solar tracker support frame 102.

As also shown for the embodiment at FIG. 3D, brace member 304A of the first brace and hard stop member 301 can extend between the frame legs 110, 111 below the bridge 112 and below the first hard stop member 303A at the first side of the multi-leg solar tracker support frame 102, and brace member 304B of the second brace and hard stop member 302 can extend between the frame legs 110, 111 below the bridge 112 and below the second hard stop member 303B at the first side of the multi-leg solar tracker support frame 102. For example, the first brace member first arm 315 of the first brace member 304A can extend parallel to the bridge 112 between frame legs 110, 111 at the first side of the multi-leg solar tracker support frame 102 and the first brace member arm 311 can extend at a skewed angle between the frame legs 110, 111 at the first side of the multi-leg solar tracker support frame 102. Likewise, the second brace member first arm 318 of the second brace member 304B can extend parallel to the bridge 112 between frame legs 110, 111 at the second side of the multi-leg solar tracker support frame 102 and the second brace member second arm 313 can extend at a skewed angle between frame legs 110, 111 at the second side of the multi-leg solar tracker support frame 102. The illustrated example shows the first brace and hard stop member 301 having the first brace member 304A as integral with the first hard stop member 303A and the second brace and hard stop member 302 having the second brace member 304B as integral with the second hard stop member 303B.

Each of the first and second brace and hard stop members 301, 302 are illustrated here to include the interference surface 305 as a curved interference surface. For such an example, the first hard stop member 303A can be coupled to the bridge 112 and at least one of the legs 110, 111 (e.g., only one of the legs 110, 111) such that the interference surface 305 at the first hard stop member 303A curves from the bridge 112 to the frame legs 110. Similarly, the second hard stop member 303B can be coupled to the bridge 112 and at least one of the legs 110, 111 (e.g., only one of the legs 110, 111 that is the other of the legs from which the first hard stop member 303A is coupled) such that the interference surface 305 at the second hard stop member 303B curves from the bridge 112 to the frame leg 111. As illustrated at FIG. 3D, the bearing sleeve 120 can include first bearing sleeve portion 124 and hanging bearing sleeve portion 126, with the first bearing sleeve portion 124 interfacing with the bridge 112, the hanging bearing sleeve portion 126 extending out from the first bearing sleeve portion 124 below the bridge 112 such that the hanging bearing sleeve portion 126 is at a common elevation with the interference surface 305.

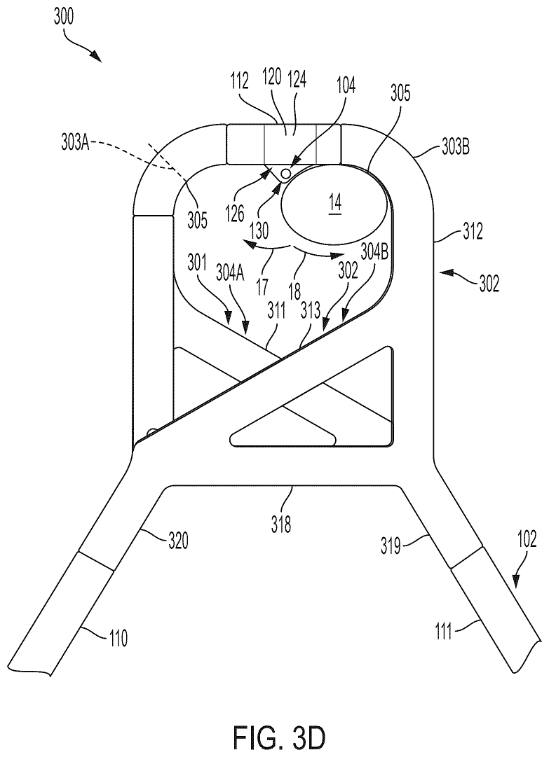

FIGS. 4A-4C illustrate another exemplary embodiment of a solar tracker support frame assembly 400. FIG. 4A is a perspective view of an embodiment of a first brace and hard stop member 401, FIG. 4B is a perspective view of an embodiment of a second brace and hard stop member 402, and FIG. 4C is a perspective view of the solar tracker support frame assembly 400 with the first and second brace and hard stop members 401, 402 assembled at a multi-leg solar tracker support frame 102.

The first brace and hard stop member 401 can be similar to, or the same as, the first brace and hard stop member 301 disclosed previously herein except as otherwise noted here, and, likewise, the second brace and hard stop member 402 can be similar to, or the same as, the second brace and hard stop member 302 disclosed previously herein except as otherwise noted here. In particular, the first brace and hard stop member 401 can include the first hard stop member 303A and the first brace member 304A, and the second brace and hard stop member 402 can include the second hard stop member 303B and the second brace member 304B. As illustrated here, the first brace member 304A at the first brace and hard stop member 401 can include the first base 310 and the first brace member arm 311, but the first brace member 304A at the first brace and hard stop member 401 can lack the first member brace arm 315, the first member second brace arm 316, and the first member third brace arm 317. Likewise, the second brace member 304B at the second brace and hard stop member 402 can include the second base 312 and the second brace member arm 313, but the second brace member 304B at the second brace and hard stop member 402 can lack the second member first brace arm 318, the second member second brace arm 319, and the second member third brace arm 320.

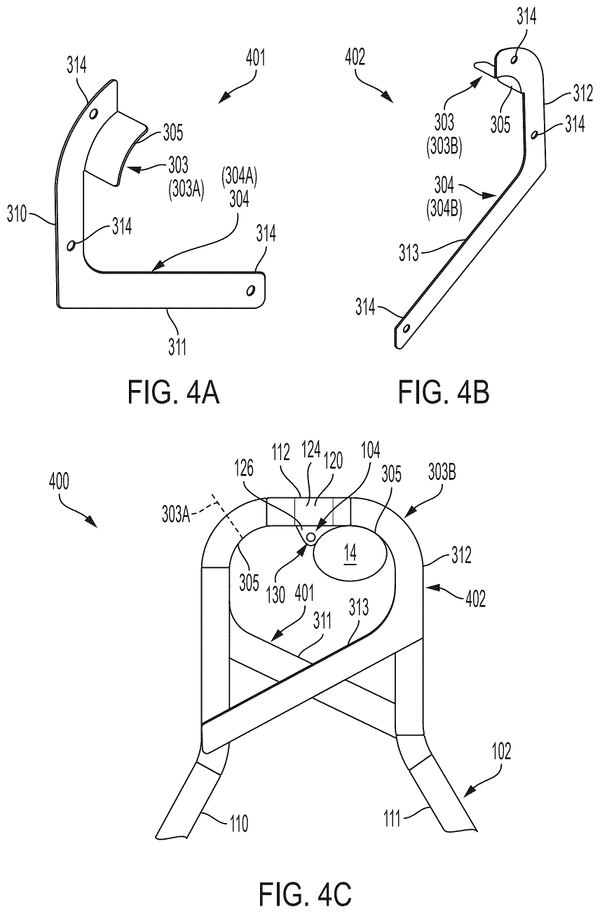

FIGS. 5A and 5B illustrate another exemplary embodiment of a solar tracker support frame assembly 500 with first and second brace and hard stop members 501, 502 assembled at a multi-leg solar tracker support frame 102. The first and second brace and hard stop members 501, 502 can be similar to, or the same as, the first and second brace and hard stop members 401, 402 disclosed previously herein except that the brace member and hard stop member at each of the first and second brace and hard stop members 501, 502 are separate, non-integral components of each of the first and second brace and hard stop members 501, 502. FIG. 5A is a perspective view of a first side of the solar tracker support frame assembly 500, and FIG. 5B is a perspective view of a second, opposite side of the solar tracker support frame assembly 500.

The first brace and hard stop member 501 can be similar to, or the same as, the first brace and hard stop member 401 disclosed previously herein except as otherwise noted here, and, likewise, the second brace and hard stop member 502 can be similar to, or the same as, the second brace and hard stop member 402 disclosed previously herein except as otherwise noted here. In particular, the first brace and hard stop member 501 can include the first hard stop member 303A and the first brace member 304A, and the second brace and hard stop member 502 can include the second hard stop member 303B and the second brace member 304B. As illustrated here, the first brace member 304A and the first hard stop member 303A at the first brace and hard stop member 501 can be separate components (e.g., non-integral components separately coupled to the frame 102), and the second brace member 304B and the second hard stop member 303B at the second brace and hard stop member 502 can be separate components (e.g., non-integral components separately coupled to the frame 102). The first brace member 304A can include the first brace member arm 311, but the first brace member 304A as a component of the first brace and hard stop member 501 can lack the first base 310, the first member brace arm 315, the first member second brace arm 316, and the first member third brace arm 317. Likewise, the second brace member 304B can include the second brace member arm 313, but the second brace member 304B as a component of the second brace and hard stop member 502 can lack the second base 312, the second member first brace arm 318, the second member second brace arm 319, and the second member third brace arm 320.

For some embodiments, such as seen here at FIGS. 5A and 5B, the interference surface 305 at each hard stop member 303A, 303B can extend out from a side of the frame 102 opposite a side of the frame 102 at which the respective skewed brace member arm 311, 313 is coupled to the frame. For instance, the interference surface 305 at the first hard stop member 303A at the first brace and hard stop member 501 can project out from a side of the frame 102 that is opposite a side of the frame where the brace member arm 311 is coupled. Similarly, the interference surface 305 at the second hard stop member 303B at the second brace and hard stop member 502 can project out from a side of the frame 102 that is opposite a side of the frame where the brace member arm 313 is coupled. This can be the case also for the embodiments shown at FIGS. 3A-4C. Though for other examples within the scope of this disclosure the interference surface 305 can project out from the frame at a same side as the respective skewed brace member arm 311, 313.

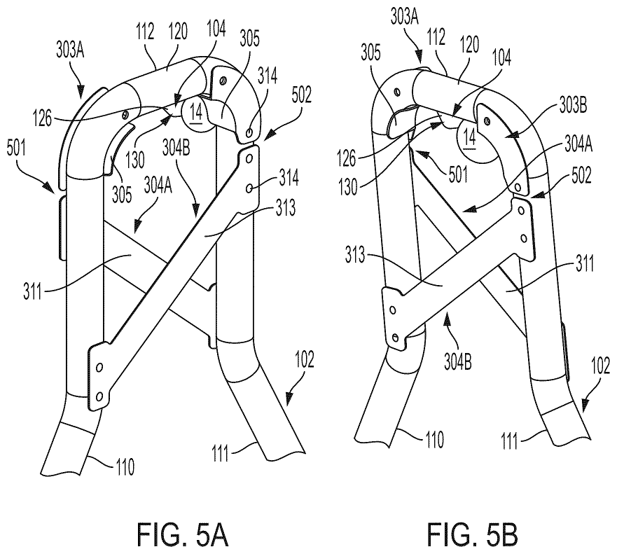

FIGS. 6A-8C illustrate embodiments of a hard stop member. Any one or more of the features of the hard stop member disclosed at FIGS. 6A-8C can be included at the hard stop members disclosed previously herein, for instance, include at any of the hard stop members disclosed previously herein in reference to FIGS. 3A-5B. For example, first and second hard stop members 303A, 303B can include any one or more of the features disclosed herein in reference to FIGS. 6A-8C.

FIGS. 6A and 6B illustrate one exemplary embodiment of interference surface 305 at hard stop member 303. FIG. 6A is an elevational view of a pair of hard stop members 303 coupled to frame 102—with one hard stop member 303A extending along leg 110 and bridge 112 and the other hard stop member 303B extending along leg 111 and bridge 112. FIG. 6B is an elevational view of the hard stop member 303 showing the exemplary embodiment of the interference surface 305.

As shown for the embodiment here, the interference surface 305 can include a first planar interference end surface 601 at one end of the interference surface 305, a second planar interference end surface 602 at another, opposite end of the interference surface 305, and an intermediate planar interference surface 603 between the first planar interference end surface 601 and the second planar interference end surface 602. For some examples, such as that shown here, the first planar interference end surface 601 can be connected to the intermediate planar interference surface 603 via a first curved, non-planar transition surface 604, and the second planar interference end surface 602 can be connected to the intermediate planar interference surface 603 via a second curved, non-planar transition surface 605. The inclusion of such one or more planar surfaces 601, 602, 603 at the interference surface 305 of the hard stop member 303 can be useful in providing sufficient surface area at the interference surface 305 to help spread a load along the interference surface 305 resulting from contact of the torque tube 14 at the interference surface 305.

As also shown for the embodiment here, the hard stop member 303 can include a vertical end wall 605 and a flange 606. The flange 606 can include the interference surface 305, and the vertical end wall 605 can extend out (e.g., up) from the flange 606 in a different direction than the interference surface 305. The vertical end wall 605 can include one or more coupling apertures 314 for coupling the hard stop member 303 to the multi-leg solar tracker support frame 102. The flange 606 can extend out from the vertical end wall, for instance such that the flange 606 is generally oriented normal to the vertical end wall 605, and the interference surface 305 can be formed at the flange 606. Thus, for this embodiment, the flange 606 can include each of the first planar interference end surface 601, intermediate planar interference surface 603, first curved, non-planar transition surface 604, and second planar interference end surface 602, and the second curved, non-planar transition surface 605.

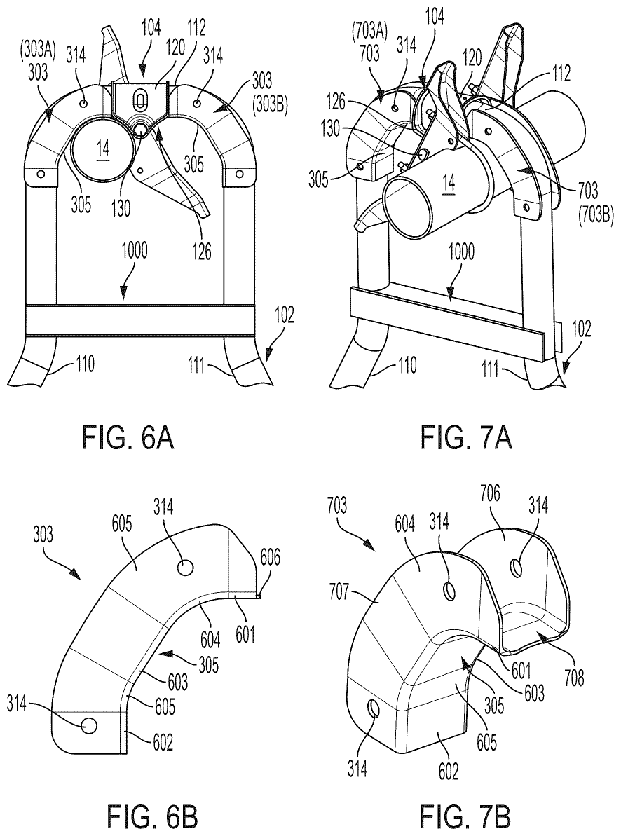

FIGS. 7A and 7B illustrate another exemplary embodiment with interference surface 305 at another embodiment of a hard stop member 703. The hard stop member 703 can be similar to, or the same as, the hard stop member 303 disclosed previously herein except as otherwise disclosed here in refence to FIGS. 7A-7B. FIG. 7A is a perspective view of a solar tracker support frame assembly having hard stop member 703, and FIG. 7B is a perspective view of the hard stop member 703 with the embodiment of the interference surface 305.

The interference surface 305 at the hard stop member 703 can include the first planar interference end surface 601, the second planar interference end surface 602, and the intermediate planar interference surface 603 between the first planar interference end surface 601 and the second planar interference end surface 602. The interference surface 305 can also include the first curved, non-planar transition surface 604 and the second curved, non-planar transition surface 605.

In addition, the hard stop member 703 can include a pair of vertical end walls 706, 707 and a horizontal end wall 708. First vertical end wall 706 can include one or more coupling apertures 314, and second vertical end wall 707 can include one or more coupling apertures 314. The second vertical end wall 707 can be spaced apart from the first vertical end wall 706, and the horizontal end wall 708 can extend between the first and second vertical end walls 706, 707. The interference surface 305 can be at the horizontal end wall 708 and thus can be between the first and second vertical end walls 706, 707. The first and second vertical end walls 706, 707 can extend out (e.g., up) from the interference surface 305 so as to create a channel therebetween for coupling to one of the legs 110 or 111 and the bridge 112 as shown for the illustrated example. The embodiment of the hard stop member 703 including opposing first and second vertical end walls 706, 707 can be configured to couple to both of opposite sides of the frame 102. For example, hard stop member 703 can be configured to couple leg 110 or 111 and to bridge 112 at both of two opposite sides of the frame 102 via coupling apertures 314 at the respective first and second vertical end walls 706, 707.

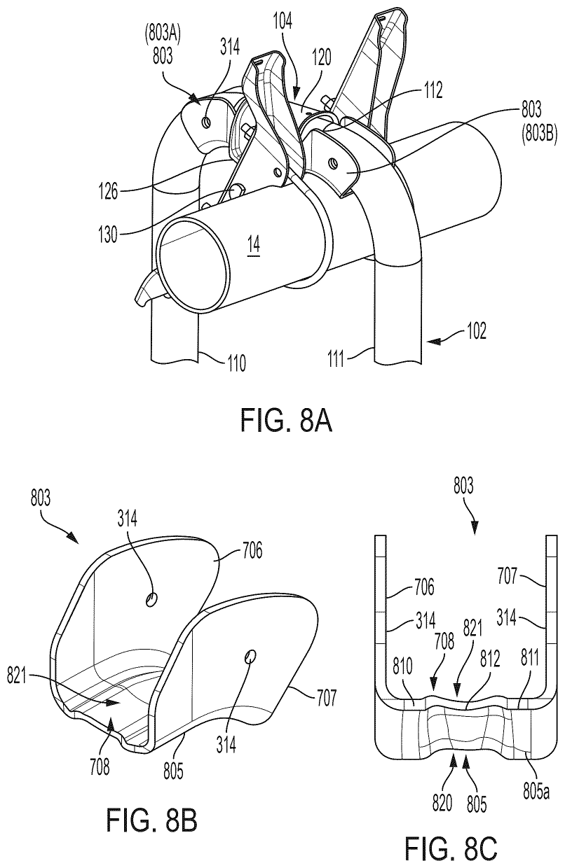

FIGS. 8A-8C illustrate another exemplary embodiment of an interference surface 805 that can be included at any of a variety of hard stop embodiments. FIG. 8A is a perspective view of a solar tracker support frame assembly having a pair of hard stop members 803, with the interference surface 805, coupled to the frame 102—with one hard stop member 803A extending along leg 110 and bridge 112 and the other hard stop member 803B extending along leg 111 and bridge 112. FIG. 8B is a perspective view of the embodiment of the hard stop 803 with the embodiment of the interference surface 805, and FIG. 8C is an elevational view of the hard stop 803 with the embodiment of the interference surface 805. For some examples, the hard stop member 803 can be similar to, or the same as, the hard stop member 703 disclosed previously except with a different configuration of the interference surface 805. Namely, the hard stop member 803 can include the first vertical end wall 706 that includes one or more first coupling apertures 314, the second vertical end wall 707 that includes one or more second coupling apertures 314, and the horizontal end wall 708 that extends between the first and second vertical end walls 706, 707. As shown, the first and second vertical end walls 706, 707 and the horizontal end wall 708 can define a channel to receive, and couple thereat, to the frame 102.

The interference surface 805 of the hard stop member 803 can be formed at the horizontal end wall 708. The interference surface 805 can include a first lower interference surface 810 at a first side of the interference surface 805, a second lower interference surface 811 at a second, opposite side of the interference surface 805, and an intermediate raised interference surface 812 between the first and second lower interference surfaces 810, 811. As illustrated for the example shown here, a bottom side 805a of the hard stop member 803 can define the interference surface 805. The first lower interference surface 810 and the second lower interference surface 811 can be at a different elevation at the bottom side 805a than the intermediate raised interference surface 812. In particular, for the illustrated example of the interference surface 805, the intermediate raised interference surface 812 is elevated higher along the bottom side 805a than each of the first and second lower interference surfaces 810, 811. Thus, the extent of the bottoms side 805a at the horizontal end wall 708, which can define the interference surface 805, can vary in elevation along its length between the first and second vertical end walls 706, 707.

The varied elevation along the interference surface 805 can help to create a type of cradle area 820 at the interference surface 805 to receive (e.g., and contact) the torque tube 14. For example, such cradle area 820 can be defined at the intermediate raised interference surface 812 between the first and second lower interference surfaces 810, 811. For instance, the cradle area 820 can receive (e.g., and contact) the torque tube 14 when the torque tube 14 is at a maximum tilt angular position (e.g., sixty degree stowed position of the torque tube 14). As one example, the interference surface 805, including the cradle area 820, can be formed at the hard stop member 803 via stamping. In some examples, a frame interface surface 821 can be defined opposite the intermediate raised interference surface 812. The frame interface surface 821 can define a surface contour that corresponds to a cross-sectional geometry of the frame 102. For instance, for application where the hard stop member 803 is to be coupled to the frame 102 at least at bridge 112 and bridge 112 has a circular cross-sectional geometry, the surface contour at the frame interface surface 821 can be semi-circular as shown at FIG. 8C to enable the frame interface surface 821 to sit and couple at a flush orientation to the bridge 112.

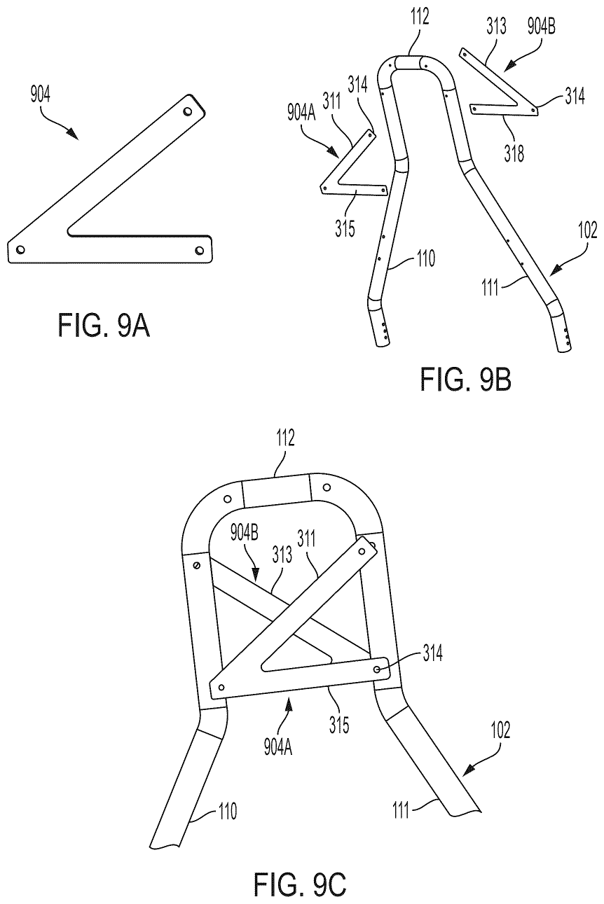

FIGS. 9A-9C illustrate an exemplary embodiment of a brace member 904. FIG. 9A is a perspective view of the embodiment of the brace member 904, FIG. 9B is an exploded view showing assembly of a first such brace member 904A and a second such brace member 904B at the multi-leg solar tracker support frame 102, and FIG. 9C is an elevational view of the solar tracker support frame assembly of FIG. 9B with the first and second brace members 904A, 904B coupled to the multi-leg solar tracker support frame 102 via one or more coupling apertures 314.

Brace member 904A can include the first brace member arm 311 and the first member first brace arm 315. As shown here, the first member first brace arm 315 can be configured to extend generally parallel to the bridge 112 between the legs 110, 111 at one side of the frame 102, while the first brace member arm 311 can extend at a skewed angle (e.g., ranging between zero and ninety degrees, such as between thirty and sixty degrees) relative to the first member first brace arm 315. Brace member 904B can include the second brace member arm 313 and the second member first brace arm 318. As shown here, the second member first brace arm 318 can be configured to extend generally parallel to the bridge 112 between the legs 110, 111 at an opposite side of the frame 102 as the first member first brace arm 315, while the second brace member arm 313 can extend at a skewed angle (e.g., ranging between zero and ninety degrees, such as between thirty and sixty degrees) relative to the second member first brace arm 318. In some applications the first and second brace members 904A, 904B can be manufactured as the same component and then applied at inverse orientations at opposite sides of the frame 102. Each of the first and second brace members 904A, 904B can include one or more coupling apertures 314 to couple each of the first and second brace members 904A, 904B to the frame 102. For instance, the first brace member 904A can be coupled to the leg 111 at each of spaced apart locations at coupling aperture 314 at the first brace member arm 311 at the leg 111 and at coupling aperture 314 at the first member first brace arm 315 at the leg 111, and the first brace member 904A can be coupled to the leg 110 at coupling aperture 314 at an intersection of the first brace member arm 311 and the first member first brace arm 315. Similarly, the second brace member 904B can be coupled to the leg 110 at each of spaced apart locations at coupling aperture 314 at the second brace member arm 313 at leg 110 and at coupling aperture 314 at the second member first brace arm 318 at leg 110, and the second brace member 904B can be coupled to the leg 111 at coupling aperture 314 at an intersection of the second brace member arm 313 and the second member first brace arm 318.

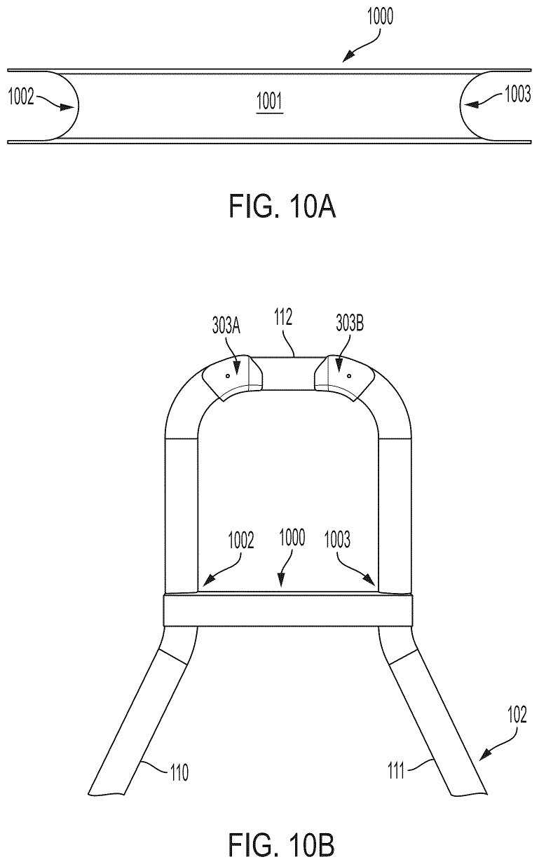

FIGS. 10A and 10B illustrate another exemplary embodiment of a brace member 1000. FIG. 10A is a plan view of the brace member 1000, and FIG. 10B is an elevational view of a solar tracker support frame assembly with the brace member 1000 assembled at multi-leg solar tracker support frame 102.

The brace member 1000 can be configured to extend generally parallel to the bridge 112 of the frame 102. The brace member 1000 can include a brace body 1001. The brace body 1001 can include a first leg receptacle 1002 at one side of brace body 1001 and a second leg receptacle 1003 at another, opposite side of brace body 1001. The first leg receptacle 1002 can be configured to interface with leg 110 of frame 102 and the second leg receptacle 1003 can be configured to interface with leg 111 of frame 102. As such, the brace member 1000 can be configured to provide a type of cross brace at the frame 102 which can help to stabilize the frame 102 during applied wind loads in the field. For some exemplary applications, the brace member 1000 can be so configured to provide a type of cross brace at the frame 102 such that the brace body 1001 extends between the legs 110, 111 of the frame 102 below the torque tube which torque tube can be below the bridge 112.

Various examples have been described. These and other examples are within the scope of the following claims.

What is claimed is:

1. A solar tracker support frame assembly comprising:
a multi-leg solar tracker support frame comprising a first frame leg, a second frame leg, and a bridge extending between the first frame leg and the second frame leg;
a hanging bearing housing assembly at the multi-leg solar tracker support frame and configured to support a torque tube, the hanging bearing housing assembly comprising a bearing sleeve and a torque tube connector, the torque tube connector configured to couple the torque tube to the bearing sleeve below the bridge; and
a hard stop member interfacing with at least one of the first frame leg, the second frame leg, and the bridge, the hard stop member comprising an interference surface configured to contact the torque tube and thereby impede further movement of the torque tube beyond the interference surface.

2. The assembly of claim 1, wherein the hard stop member interfaces with the bridge and at least one of the first frame leg and the second frame leg such that the hard stop member extends along the bridge and the at least one of the first frame leg and the second frame leg.

3. The assembly of claim 1,
wherein the hard stop member is a first hard stop member and the interference surface is a first interference surface, wherein the first hard stop member interfaces with the first frame leg and the bridge, and wherein the first interference surface is configured to contact the torque tube and thereby impede further movement of the torque tube beyond the interference surface in a first direction, and
further comprising:
a second hard stop member interfacing with the second frame leg and the bridge, wherein the second hard stop member includes a second interference surface configured to contact the torque tube and thereby impede further movement of the torque tube beyond the interference surface in a second direction that is opposite the first direction.

4. The assembly of claim 3,
wherein the first hard stop member interfaces with the first frame leg and the bridge at a first side of the multi-leg solar tracker support frame, and
wherein the second hard stop member interfaces with the second frame leg and the bridge at a second side of the multi-leg solar tracker support frame opposite the first side.

5. The assembly of claim 4, further comprising:
a brace member extending between the first frame leg and the second frame leg below the bridge and below the hard stop member,
wherein the brace member is a first brace member extending between the first frame leg and the second frame leg below the bridge and below the first hard stop member at the first side of the multi-leg solar tracker support frame, and
further comprising:
a second brace member extending between the first frame leg and the second frame leg below the bridge and below the second hard stop member at the second side of the multi-leg solar tracker support frame.

6. The assembly of claim 5,
wherein the first brace member includes a first brace member first arm that extends parallel to the bridge between the first frame leg and the second frame leg at the first side of the multi-leg solar tracker support frame and a first brace member second arm that extends at a skewed angle between the first frame leg and the second frame leg at the first side of the multi-leg solar tracker support frame, and
wherein the second brace member includes a second brace member first arm that extends parallel to the bridge between the first frame leg and the second frame leg at the second side of the multi-leg solar tracker support frame and a second brace member second arm that extends at a skewed angle between the first frame leg and the second frame leg at the second side of the multi-leg solar tracker support frame.

7. The assembly of claim 6, wherein the first brace member is integral with the first hard stop member, and wherein the second brace member is integral with the second hard stop member.

8. The assembly of claim 1, wherein the interference surface included at the hard stop member comprises a first planar interference end surface at one end of the interference surface, a second planar interference end surface at another, opposite end of the interference surface, and an intermediate planar interference surface between the first planar interference end surface and the second planar interference end surface.

9. The assembly of claim 8,
wherein the hard stop member comprises a vertical end wall that includes one or more coupling apertures for coupling the hard stop member to the multi-leg solar tracker support frame, and
wherein the hard stop member further comprises a flange that extends out from the vertical end wall, the interference surface formed at the flange.

10. The assembly of claim 8,
wherein the hard stop member comprises:
a first vertical end wall that includes one or more first coupling apertures
a second vertical end wall that includes one or more second coupling apertures, the second vertical end wall spaced apart from the first vertical end wall, and
a horizontal end wall that extends between the first vertical end wall and the second vertical end wall, the interference surface formed at the horizontal end wall.

11. The assembly of claim 1, wherein the interference surface included at the hard stop member comprises a first lower interference surface at a first side of the interference surface, a second lower interference surface at a second, opposite side of the interference surface, and an intermediate raised interference surface between the first lower interference surface and the second lower interference surface.

12. The assembly of claim 11,
wherein the hard stop member comprises:
a first vertical end wall that includes one or more first coupling apertures
a second vertical end wall that includes one or more second coupling apertures, the second vertical end wall spaced apart from the first end vertical wall, and
a horizontal end wall that extends between the first vertical end wall and the second vertical end wall, the interference surface formed at the horizontal end wall.

13. The assembly of claim 1, wherein the hard stop member is coupled to the bridge and at least one of the first frame leg and the second frame leg such that the interference surface curves from the bridge to the at least one of the first frame leg and the second frame leg.

14. The assembly of claim 13, wherein the bearing sleeve comprises a first bearing sleeve portion and a hanging bearing sleeve portion, the first bearing sleeve portion interfacing with the bridge, the hanging bearing sleeve portion extending out from the first bearing sleeve portion below the bridge such that the hanging bearing sleeve portion is at a common elevation with the interference surface.

15. The assembly of claim 14, wherein the torque tube connector comprises a pin.

16. A solar tracker brace and hard stop system comprising:
a first brace and hard stop member comprising a first base, a first brace member extending out from the first base at an angle between zero and ninety degrees, and a first hard stop member extending out from the first base, the first hard stop member comprising a first interference surface configured to contact a torque tube and thereby impede further movement of the torque tube in a first direction beyond the first interference surface, the first interference surface extending out from the first base in a direction perpendicular to a direction at which the first brace member extends out from the first base; and
a second brace and hard stop member comprising a second base, a second brace member extending out from the second base at an angle between zero and ninety degrees, and a second hard stop member extending out from the second base, the second hard stop member comprising a second interference surface configured to contact the torque tube and thereby impede further movement of the torque tube in a second direction, opposite the first direction, beyond the second interference surface, the second interference surface extending out from the second base in a direction perpendicular to a direction at which the second brace member extends out from the second base.

17. The system of claim 16,
wherein each of the first base, the first brace member, and the first hard stop member include at least one coupling aperture, and
wherein each of the second base, the second brace member, and the second hard stop member include at least one coupling aperture.

18. The system of claim 16,
wherein the first brace member of the first brace and hard stop member further comprises a first member first brace arm extending out from, and perpendicular to, the first base, and
wherein the second brace member of the second brace and hard stop member further comprises a second member first brace arm extending out from, and perpendicular to, the second base.

19. The system of claim 18,
wherein the first brace member of the first brace and hard stop member further comprises a first member second brace arm extending out from the first brace member first arm at a side of the first brace member first arm opposite the first base, the first brace member second arm including at least one coupling aperture, and
wherein the second brace member of the second brace and hard stop member further comprises a second member second brace arm extending out from the second brace member first arm at a side of the second brace member first arm opposite the second base, the second brace member second arm including at least one coupling aperture.

20. The system of claim 19,
wherein the first brace member of the first brace and hard stop member further comprises a first member third brace arm extending out from the first base in a direction opposite the first member first brace arm, and
wherein the second brace member of the second brace and hard stop member further comprises a second member third brace arm extending out from the second base in a direction opposite the second member first brace arm.
